(19) United States
(12) Patent Application Publication
(10) Pub. No.: US 2005/0157288 A1
(43) Pub. Date: Jul. 21, 2005

(54) Zero-force pellicle mount and method for manufacturing the same

(75) Inventors: Christian K. Van Peski, Cedar Creek, TX (US); Andrew Grenville, Newton, MA (US)

Correspondence Address: FULBRIGHT & JAWORSKI L.L.P., 600 CONGRESS AVE., SUITE 2400, AUSTIN, TX, 78701, US

(73) Assignee: SEMATECH, Inc.

(21) Appl. No.: 10/996,807

(22) Filed: Nov. 24, 2004

Related U.S. Application Data
(60) Provisional application No. 60/525,499, filed on Nov. 26, 2003.

(51) Int. Cl. G03B 27/52

(52) U.S. Cl. 355/75; 430/5

(57) ABSTRACT

Methods and apparatuses for mounting a pellicle to a reticle is provided. A multi-support point pellicle holder supports a pellicle, such as a fused silica pellicle, and a multi-support point holder supports the reticle, where each point on the respective frame provides a substantially equal-force. An adhesive is added to the pellicle, where upon attaching the reticle pellicle, the weight of the reticle causes the adhesive spots to form a wider bonding layer, adhering the pellicle to the reticle. The adhesive layer is cured and a sealant is added in the spaces between the adhesive spots.

This patent application claims priority to, and incorporates by reference in its entirety, U.S. Provisional Patent Application Ser. No. 60/525,499 filed on Nov. 26, 2003.

### BACKGROUND OF THE INVENTION

1. Field of the Invention

This invention relates to the field of semiconductor lithography and more specifically to mounting a fused silica pellicle to a reticle.

2. Discussion of the Related Art

In the production of semiconductor devices, there are a number of lithographic exposure steps in which an image is projected onto a photosensitive material coating on a semiconductor wafer. The image is projected using a photomask which must be kept clean because any undesired particles on the surface may alter the image on the wafer and cause a defect.

A common method to achieve this goal has been the application of a protective membrane spaced apart from the mask by a few millimeters. At this offset, particles on the protective membrane will be out of focus and not imaged onto the wafer. This membrane, referred to as a “pellicle”, has been common practice in the semiconductor industry for a few decades. The pellicle typically includes a polymer membrane, approximately one micrometer thick, is stretched over a frame and is generally affixed to a mask, also referred to as a “reticle”. Although the pellicle is in the optical path, the polymer thickness is small so that effect on the imaging performance is negligible.

For 157 nanometer wavelengths exposure, all known polymers degrade to such an extent that they are unusable as pellicle material. Consequently, a fused silica plate is being considered as a pellicle in place of the polymer membrane. For structural reasons, 0.8 millimeters has been selected as the fused silica plate thickness. At such a thickness, the optical effects can be considerable. Further, the flatness of the fused silica plate must be very well controlled to keep pattern distortion to an acceptable level. Current specifications require that the pellicle have a slope of no greater than 10 micro radians at any point.

In order to achieve the desired slope requirements, the pellicle should be substantially flat to approximately 10 micrometer after mounting to the reticle. However, current technology places a solid adhesive gasket (SAG) on the pellicle frame. The pellicle and reticle are then pressed together to form a bond. The mounting force applied deforms the SAG, which relaxes in a non-linear manner and distorts the fused silica pellicle as well as the reticle.

The referenced shortcomings are not intended to be exhaustive, but rather are among many that tend to impair the effectiveness of previously known techniques concerning pellicle design; however, those mentioned here are sufficient to demonstrate that the methodologies appearing in the art have not been satisfactory and that a significant need exists for the techniques described and claimed in this disclosure.

### SUMMARY OF THE INVENTION

The present invention provides a method and an apparatus for attaching a pellicle, such as a fused silica pellicle, to a reticle. According to one aspect of the invention, the method may provide a multi-support point pellicle holder for providing a substantially equal support force at each of the points. In some respects, the multi-support point pellicle holder may include six supports pins. Alternatively, the multi-support point pellicle holder may include eight support pins. The method also provides a multi-support point reticle holder for providing a substantially equal support force at each of the four points. In some respects, the multi-support point reticle holder may include four support pins. In some embodiments, an adhesive is added to the pellicle. In one embodiment, adhesive spots are placed on the pellicle, one adhesive spot over each of the support points on the multi-support point pellicle holder. Alternatively, a contiguous adhesive layer may be added to the pellicle frame. Due to the force from the application of the reticle to the pellicle, the adhesion bonds the reticle to the pellicle with substantially no distortion.

In accordance to another aspect of the invention, the apparatus may include a multi-support point pellicle holder for supporting a pellicle with a substantially equal support force at each of the points. The multi-support point pellicle holder may include six support pins. Alternatively, the multi-support point pellicle holder may include eight support pins. Additionally, the apparatus includes a multi-support point reticle holder for supporting a reticle with a substantially equal support force at each of the points. The multi-support point reticle holder may include four support pins. In some respects, an adhesive may also be included between the reticle and the pellicle. The adhesive may bond the reticle to the pellicle when the multi-support point reticle holder is lowered onto the multi-support point pellicle holder. In one embodiment, the adhesive includes adhesive dots on the pellicle; each adhesive dot is located above each point the multi-support point pellicle holder. Alternatively, an adhesive layer is added around a pellicle frame. The weight of the multi-support point reticle holder causes the adhesive spots to spread, creating a substantially distortion-free bond between the reticle and the pellicle.

Other features and associated advantages will become apparent with reference to the following detailed description of specific embodiments in connection with the accompanying drawings.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein like reference numerals (if they occur in more than one view) designate the same elements. The invention may be better understood by reference to one or more of these drawings in combination with the description presented herein. It should be noted that the features illustrated in the drawings are not necessarily drawn to scale.

FIG. 1A is a six-support point pellicle holder, in accordance with an embodiment of the present invention.

FIG. 1B is a four-support point reticle holder, in accordance with an embodiment of the present invention.

FIG. 2 is a fused silica pellicle holder mounted to a reticle holder, in accordance with an embodiment of the present invention.

FIGS. 3A-3D are flatness maps of a fused silica pellicle, in accordance with an embodiment of the present invention.

FIGS. 4A-4B are the illustration of the differences between a fused silica pellicle before and after attaching to a reticle, in accordance with an embodiment of the present invention.

### DETAILED DESCRIPTION

The present invention presents an improved mounting method of a fused silica pellicle to a reticle without introducing distortion to the pellicle. The invention also presents an apparatus including a multi-support point holder that supports the fused silica pellicle attached to a multi-support point holder that supports the reticle. The method and apparatus departs from the current practice of optical contacting since the current technique does not allow for any possible planarity difference between the reticle and the pellicle. Furthermore, optical contacting involves heat and pressure which tends to distort the pellicle.

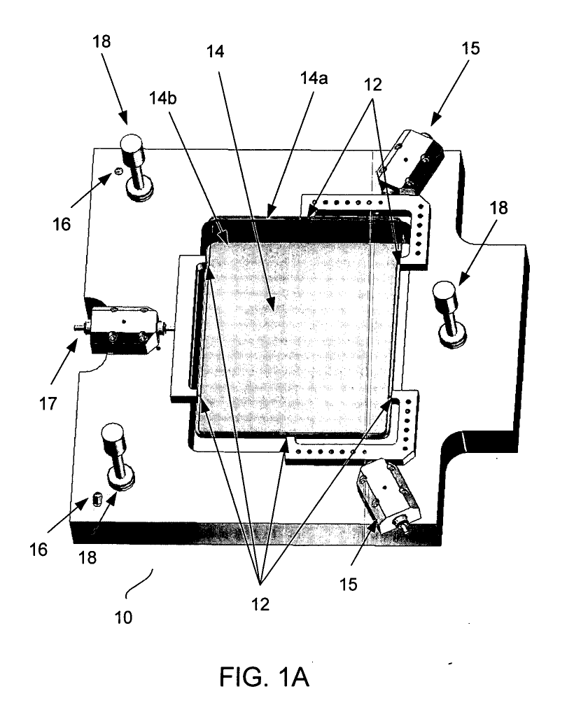

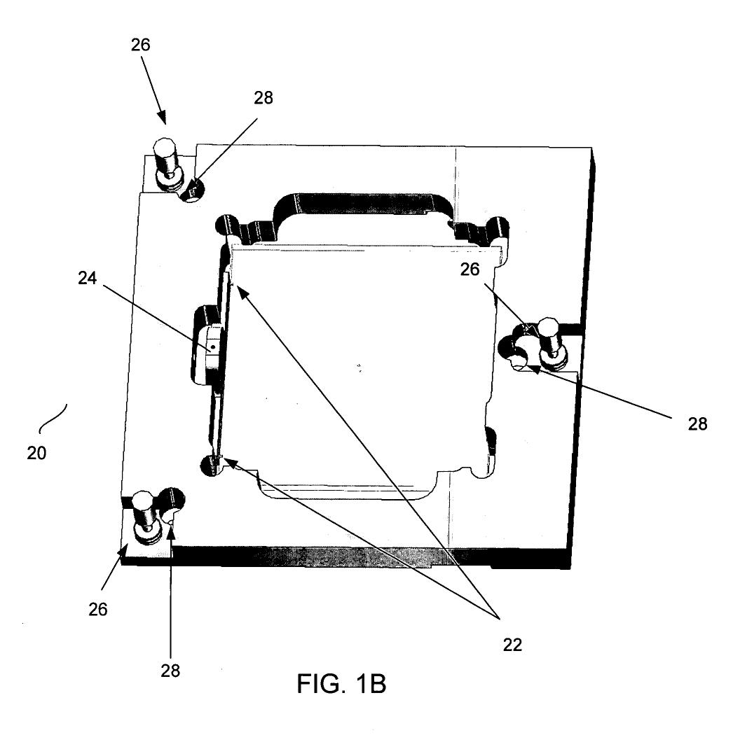

In accordance to one embodiment of the invention, a fused silica pellicle may be supported by support pins of a pellicle holder that provides an even support to the entire surface of the pellicle such that the shape of the pellicle is not altered. Referring to FIG. 1A, a six-support point pellicle holder 10 supports a pellicle 14. Fused silica pellicle 14 may include a pellicle frame 14a and a pellicle plate 14b. It is noted that pellicle holder 10 may include an eight-support pins or any other number of support pins. It is also noted that fused silica pellicle 14 is an illustrative embodiment and that other pellicles known in the art may be used. The fused silica pellicle plate 14b may be about 0.80 millimeter thick and that pellicle 14 may be used in 157 nanometer wavelength exposure techniques. The local slope of the fused silica pellicle 14 may be about 10 micro radians at most so that distortion is minimized. By providing a pellicle holder that evenly distributes an applied force onto the pellicle, the pellicle may maintain the desired slope and substantially avoid distortion.

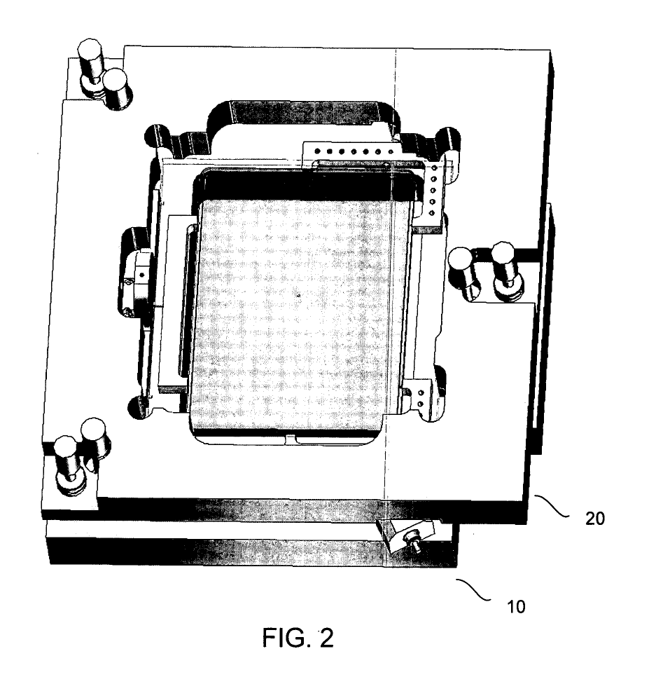

The fused silica pellicle 14 may be supported on six support pins 12, some arranged on two corner swivels 15 and others on one edge swivel 17 so that the six supporting forces are substantially equal. Pellicle holder 10 does not impart torsion forces onto the fused silica pellicle 14, and thus does not induce excessive distortion. Pellicle holder 10 also includes two dimples 16 on the upper and lower left edge to reference the adjustment screws of a reticle holder (refer to FIG. 1B) and provide for a pellicle-to-reticle registration. Additionally, pellicle holder 10 may also include three adjusting screws 18 for adjusting both pellicle holder to and reticle holder 20 (refer to FIG. 2) when placed upon an interferometer.

The present invention also includes a reticle holder which may include four-support pins. The reticle holder provides substantially equal support force on each of the four support points with precision vertical adjustment that allows for the reticle to bond with a pellicle without inducing substantial distortion. Referring to FIG. 1B, a four support pin reticle holder 20 is shown. It is noted that a reticle holder may include any number of supports so as to provide a substantially equal support force at each of the supports. Reticle holder 20 may include two support pins at the right-hand side (not shown) and two support pins 22 on swivel bar 24 at the left-hand side. The four pins provide four support points with equal force at each pin. The reticle holder 20 may also include three adjustment screws 26 which may provide for vertical adjustment relative to the pellicle holder 10 and allow for attaching of the reticle to the pellicle. In addition, the reticle holder 20 may also include clearance holes 28 in the frame to accommodate for the adjustment screws 18 on the pellicle holder 10.

In order to mount a reticle to a pellicle, adhesive dots may be applied to the pellicle 14, one adhesive dot above each of the support points. Alternatively, an adhesive layer may be applied to the pellicle frame (e.g., pellicle frame 14a). In one embodiment, the characteristics of the adhesive used may include an adhesive with a low-viscosity so that the adhesive may remain in the spot of cement on the pellicle or pellicle frame. In addition, another characteristic of the adhesive may be the ease of deformity upon an applied force. For example, upon lowering a reticle onto a pellicle, the weight of the reticle may cause the adhesive on the on pellicle to flow into a wider bond area, bonding the reticle to the pellicle. Thus, the weight of the reticle may cause the adhesive to form a bonding spot and may induce a compressive force into the pellicle.

Referring to FIG. 2, the two assemblies, the pellicle holder 10 and reticle holder 20 are shown. In one embodiment, the combined assemblies may be mounted on a Zygo MST1550 interferometer so that the planarity of the fused silica pellicle 14 may be monitored at each step. As such, the three inner adjustment screws 18 of pellicle holder 10 may allow for the adjustment of the pellicle holder 10 to be parallel to the reference flat for a Zygo measurement. In addition, three outer adjustment screws may allow for lowering the reticle holder 20 down towards the pellicle holder 10 while maintaining a substantially parallel orientation between the pellicle and the reticle.

After the mounting of the reticle to the pellicle, the adhesive between the two assemblies may be cured or set with an ultraviolet (UV) illumination source. Depending on the adhesive used, the adhesive may need to be set over a period of time. After the curing process, a sealant may be added to seal the spaces between the adhesive dots. The sealant may be used to further block particles from the assemblies.

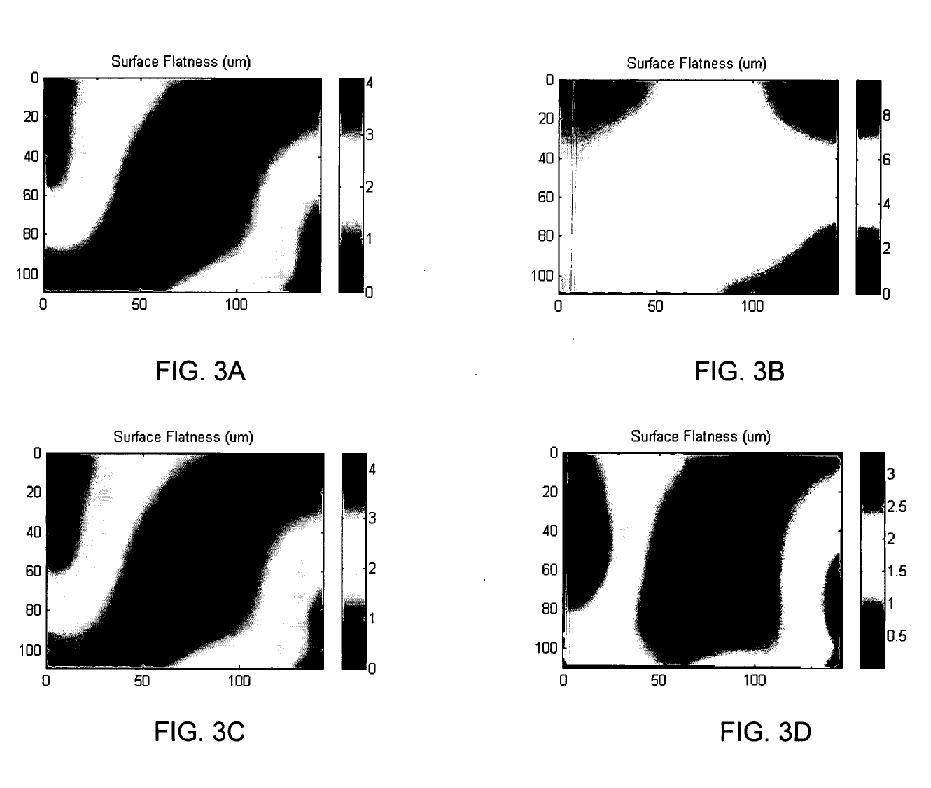

Referring to FIGS. 3A-3D, the flatness maps illustrate the surface of the fused silica pellicle 14 using an adhesive to attach the reticle to the pellicle. For example, FIG. 3A shows the flatness of the pellicle prior to adhering the reticle to the pellicle. FIG. 3B shows an induced distortion when the reticle is attached to the pellicle. While the adhesive begins to spread into a wider bonding surface due to the weight of the reticle, the pellicle begins to recovers its shape, as shown in FIG. 3C. FIG. 3D shows the flatness of the fused silica prior to sealing the adhesive with substantially no distortion when compared to FIG. 3A. As such, the added distortion may decrease as the adhesive flows to a thinner bond line. The final bond thickness was approximately 50 micrometers for this illustration.

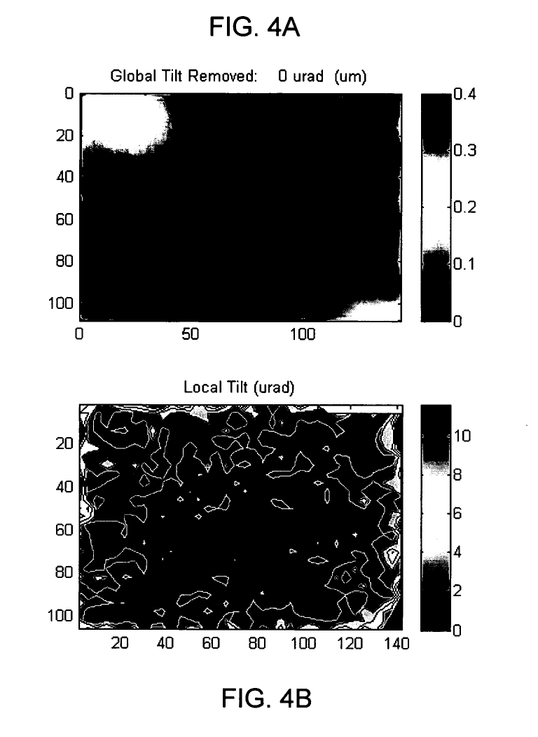

FIGS. 4A-4B illustrate the difference between before and after mounting of a reticle to a pellicle. As shown in FIGS. 4A and 4B, the pellicle distortion is added by the mounting process, where FIG. 4B shows the deviation from a best-fit plane, where FIG. 4B is the derivative of FIG. 4A and shows the local slope. As seen in FIG. 4B, the slope in most of the area is less than approximately 5 micro radians. This is less than the 10 micro radians called for in a 157 nanometer wavelength exposure technology.

In other embodiments of the invention, if an adhesive with sufficiently low deformation force is used, a layer of adhesive may be applied to the entire pellicle frame, thus eliminating the step of adding a sealant. A bending moment will be induced into the pellicle frame, but if the adhesive viscosity is low enough, the added pellicle distortion level may be at an acceptable level.

In addition, a number of adjustable supports may be used to support the fused silica pellicle and hold the fused silica pellicle in the desired plane. The adjustments to the support may be automated with feedback from an interferometer system.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope and concept of the invention as defined by the appended claims.

1. An apparatus for mounting a pellicle to a reticle, comprising:
a multi-support point pellicle holder for supporting a pellicle and for providing substantially equal support force at each support point of the pellicle holder; and
a multi-support point reticle holder coupled to the multi-support point pellicle holder, the multi-support point holder for supporting the reticle and for providing substantially equal force at each support point of the reticle holder.

2. The apparatus of claim 1, the multi-support point pellicle holder comprising a six support point pellicle holder.

3. The apparatus of claim 1, the multi-support point pellicle holder comprising a eight support point pellicle holder.

4. The apparatus of claim 1, the multi-support point pellicle holder further comprising a plurality of swivels coupled to the support points for providing a substantially equal force.

5. The apparatus of claim 1, the multi-support point reticle holder comprising a four support point reticle holder.

6. The apparatus of claim 1, the multi-support point reticle holder further comprising a plurality of screws for vertical adjustments when attaching the reticle to the pellicle.

7. The apparatus of claim 1, further comprising a substantially uniform, adhesive layer for adhering the pellicle to the reticle.

8. The apparatus of claim 1, further comprising a plurality of adhesive dots, each dot located on the pellicle above each support pin of the pellicle holder for adhering the pellicle to the reticle.

9. The apparatus of claim 1, the pellicle having a local surface slope of less than about 10 micro radians.

10. The apparatus of claim 1, the pellicle comprising a pellicle frame and a pellicle plate, the plate having a thickness of about 0.80 millimeters.

11. The apparatus of claim 1, the pellicle comprising a fused silica pellicle.

12. A method for mounting a fused silica pellicle to a reticle, comprising:
providing a six-support point frame for supporting a fused silica pellicle, the six-support point frame providing a substantially equal force on each of the six points;
providing a four-support point frame for supporting a reticle, the four-support point frame providing a substantially equal force on each of the four points;
applying an adhesive to the pellicle; and
attaching the pellicle to the reticle, the weight of the reticle creating an adhesive bond between the reticle and the pellicle.

13. The method of claim 12, further comprising setting the adhesive using ultraviolet light.

14. The method of claim 12, the step of applying an adhesive further comprising applying an adhesive layer to a pellicle frame of the pellicle for adhering the pellicle to the reticle.

15. The method of claim 12, the step of applying an adhesive further comprising applying a plurality of adhesive dots, each adhesive dot located on the pellicle above each support pin of the pellicle holder for adhering the pellicle to the reticle.

16. The method of claim 15, further comprising sealing spaces between the adhesive spots with a sealant, where the sealant prevents particles onto the fused silica pellicle.

17. The method of claim 12, the fused silica pellicle having a local surface slope of less than about 10 micro radians.

18. The method of claim 12, the fused silica pellicle comprising a pellicle frame and a pellicle plate having a thickness of about 0.80 millimeters.

19. A method for forming a substantially distortion free pellicle, comprising:
supporting a pellicle in a first multi-support point holder, each point of the first holder providing a substantially equal force;
supporting a reticle in a second multi-support point holder, each point of the second holder providing a substantially equal force;
applying an adhesive to the pellicle; and
attaching the pellicle to the reticle, the adhesive creating a bond between the pellicle and the reticle.

20. The method of claim 19, the first multi-support point frame comprising a six-point support holder.

21. The method of claim 19, the first multi-support point frame comprising an eight-point support holder.

22. The method of claim 19, the second multi-support point frame comprising a four point support holder.

23. The apparatus of claim 19, the step of applying an adhesive further comprising applying an adhesive layer to a pellicle frame of the pellicle for adhering the pellicle to the reticle.

24. The apparatus of claim 19, the step of applying an adhesive further comprising applying a plurality of adhesive dots, each adhesive dot located on the pellicle above each support pin of the pellicle holder for adhering the pellicle to the reticle.

25. The method of claim 24, further comprising sealing spaces between the adhesive dots with a sealant.

26. The method of claim 19, the pellicle comprising a fused silica pellicle.
